(19) United States
(12) Patent Application Publication
(10) Pub. No.: US 2003/0084322 A1
(43) Pub. Date: May 1, 2003

(54) System and method of an OS-integrated intrusion detection and anti-virus system

(76) Inventors: Richard L. Schertz, Raleigh, NC (US); George S. Gales, Plano, TX (US); Richard P. Tarquini, Apex, NC (US)

Correspondence Address: HEWLETT-PACKARD COMPANY, Intellectual Property Administration, P.O. Box 272400, Fort Collins, CO, 80527-2400, US

(21) Appl. No.: 10/002,072

(22) Filed: Oct. 31, 2001

(51) Int. Cl. G06F 11/30

(52) U.S. Cl. 713/200

(57) ABSTRACT

A computer comprising an operating system that controls the computer resources. An intrusion detection system is integrated with the operating system and operable to monitor the computer resources to detect, prevent and report intrusion attempts. An anti-virus system is further integrated with the operating system and operable to detect the presence of at least one virus in the computer resources.

### CROSS-REFERENCE TO RELATED APPLICATIONS

This patent application is related to co-pending U.S. patent application, Attorney Docket No. 10014010-1, entitled “METHOD AND COMPUTER READABLE MEDIUM FOR SUPPRESSING EXECUTION OF SIGNATURE FILE DIRECTIVES DURING A NETWORK EXPLOIT”; U.S. patent application, Attorney Docket No. 10016933-1, entitled “SYSTEM AND METHOD OF DEFINING THE SECURITY CONDITION OF A COMPUTER SYSTEM”; U.S. patent application, Attorney Docket No. 10017028-1, entitled “SYSTEM AND METHOD OF DEFINING THE SECURITY VULNERABILITIES OF A COMPUTER SYSTEM”; U.S. patent application, Attorney Docket No. 10017029-1, entitled “SYSTEM AND METHOD OF DEFINING UNAUTHORIZED INTRUSIONS ON A COMPUTER SYSTEM”; U.S. patent application, Attorney Docket No. 10017055-1, entitled “NETWORK INTRUSION DETECTI0N SYSTEM AND METHOD”; U.S. patent application, Attorney Docket No. 10016861-1, entitled “NODE, METHOD AND COMPUTER READABLE MEDIUM FOR INSERTING AN INTRUSION PREVENTION SYSTEM INTO A NETWORK STACK”; U.S. patent application, Attorney Docket No. 10016862-1, entitled “METHOD, COMPUTER-READABLE MEDIUM, AND NODE FOR DETECTING EXPLOITS BASED ON AN INBOUND SIGNATURE OF THE EXPLOIT AND AN OUTBOUND SIGNATURE IN RESPONSE THERETO”; U.S. patent application, Attorney Docket No. 10016591-1, entitled “NETWORK, METHOD AND COMPUTER READABLE MEDIUM FOR DISTRIBUTED SECURITY UPDATES TO SELECT NODES ON A NETWORK”; U.S. patent application, Attorney Docket No. 10014006-1, entitled “METHOD, COMPUTER READABLE MEDIUM, AND NODE FOR A THREE-LAYERED INTRUSION PREVENTION SYSTEM FOR DETECTING NETWORK EXPLOITS”; U.S. patent application, Attorney Docket No. 10002019-1, entitled “METHOD, NODE AND COMPUTER READABLE MEDIUM FOR IDENTIFYING DATA IN A NETWORK EXPLOIT”; U.S. patent application, Attorney Docket No. 10017334-1, entitled “NODE, METHOD AND COMPUTER READABLE MEDIUM FOR OPTIMIZING PERFORMANCE OF SIGNATURE RULE MATCHING IN A NETWORK”; U.S. patent application, Attorney Docket No. 10017333-1, entitled “METHOD, NODE AND COMPUTER READABLE MEDIUM FOR PERFORMING MULTIPLE SIGNATURE MATCHING IN AN INTRUSION PREVENTION SYSTEM”; U.S. patent application, Attorney Docket No. 10017330-1, entitled “USER INTERFACE FOR PRESENTING DATA FOR AN INTRUSION PROTECTION SYSTEM”; U.S. patent application, Attorney Docket No. 10017270-1, entitled “NODE AND MOBILE DEVICE FOR A MOBILE TELECOMMUNICATIONS NETWORK PROVIDING INTRUSION DETECTION”; U.S. patent application, Attorney Docket No. 10017331-1, entitled “METHOD AND COMPUTER-READABLE MEDIUM FOR INTEGRATING A DECODE ENGINE WITH AN INTRUSION DETECTION SYSTEM”; U.S. patent application, Attorney Docket No. 10017328-1, entitled “SYSTEM AND METHOD OF GRAPHICALLY DISPLAYING DATA FOR AN INTRUSION PROTECTION SYSTEM”; and U.S. patent application, Attorney Docket No. 10017303-1, entitled “SYSTEM AND METHOD OF GRAPHICALLY CORRELATING DATA FOR AN INTRUSION PROTECTION SYSTEM”.

### TECHNICAL FIELD OF THE INVENTION

The present invention relates generally to the field of computer systems and processes, and more particularly to a system and method of an operating system (OS)-integrated intrusion detection and anti-virus system.

### BACKGROUND OF THE INVENTION

Computer system security issues have become extremely important as more and more computers are connected to networks and the Internet. Attacks on computer systems have become increasingly sophisticated due to the evolution and on-line distribution of new hacker tools. Using these tools, relatively unsophisticated attackers can participate in organized attacks on one or more targeted facilities. Distributed system attacks, such as denial of service attacks, generally target hundreds or thousands of unprotected or compromised Internet nodes. Intrusion detection systems include host-based systems, network-based systems, and node-based systems. A host-based system generally monitors user activity on the system by examining alert messages, log files, etc. A network-based system typically monitors all network activity and network traffic. A node-based system may monitor network activity to and from a specific computer system to detect attacks. The node-based intrusion detection system is capable of preventing attacks, while the other two types generally cannot. The term “intrusion detection” and “intrusion protection” will be used interchangeably herein to encompass detecting intrusion as well as attempting remedies and repairs.

Another attack on the integrity of computer systems is viruses and worms. A virus is software designed to trick a user into executing it, which causes it to replicate and distribute itself. For example, boot viruses place their code in the boot sector of memory so that the virus is automatically executed upon booting. File viruses attach to executable program files in such a way that when you run the infected program, the virus code executes. Macro viruses attach to templates and other files in such a way that, when an application loads the macro file and executes the instructions in it, the first instructions to execute are those of a virus. A companion virus attaches to the operating system, rather than files or sectors. The companion virus places its code in a COM file whose first name matches the name of an existing EXE. You run “ABC”, and the actual operating system search sequence is “ABC.COM”, “ABC.EXE.” Worms also make copies of themselves, but they need not attach to particular files or sectors, and upon execution they seek other systems—rather than parts of systems—to infect, then copies its code to them. The term virus will be used hereinafter to broadly encompass any software code that act like a virus, worm, or any variant thereof.

Because of the pervasive and mutatable nature of viruses, worms, and attack tools, even today's best intrusion detection and anti-virus systems may fail to adequately protect the integrity of computer resources and data.

### SUMMARY OF THE INVENTION

In an embodiment of the present invention, a computer comprises an operating system controlling at least one computer resource. An intrusion detection system is integrated with the operating system and operable to monitor the computer resources to detect, prevent and report intrusion attempts.

In yet another embodiment of the present invention, a method includes the steps of executing an OS-integrated intrusion detection system, and monitoring at least one computer resource of the computer to detect, prevent and report intrusion attempts.

In yet another embodiment of the present invention, a method includes the steps of executing an OS-integrated anti-virus system, and monitoring at least one computer resource to detect and report presence of viruses.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified block diagram of an intrusion protection system (IPS) and anti-virus system integrated with a computer system's operating system according to the teachings of the present invention;

FIG. 2 is a block diagram of a computer system deploying operating system integrated network-based, host-based and inline intrusion protection systems;

FIG. 3 is a block diagram of an embodiment of an intrusion protection system-integrated between predetermined layers of the network layered protocol according to the teachings of the present invention;

FIG. 4 is a top level flowchart showing the detection of fragmented network attack according to the present invention; and

FIG. 5 is a simplified diagram illustrating the comprehensive nature of an OS-integrated anti-virus system in detecting and preventing a virus infection of the computer system.

### DETAILED DESCRIPTION OF THE DRAWINGS

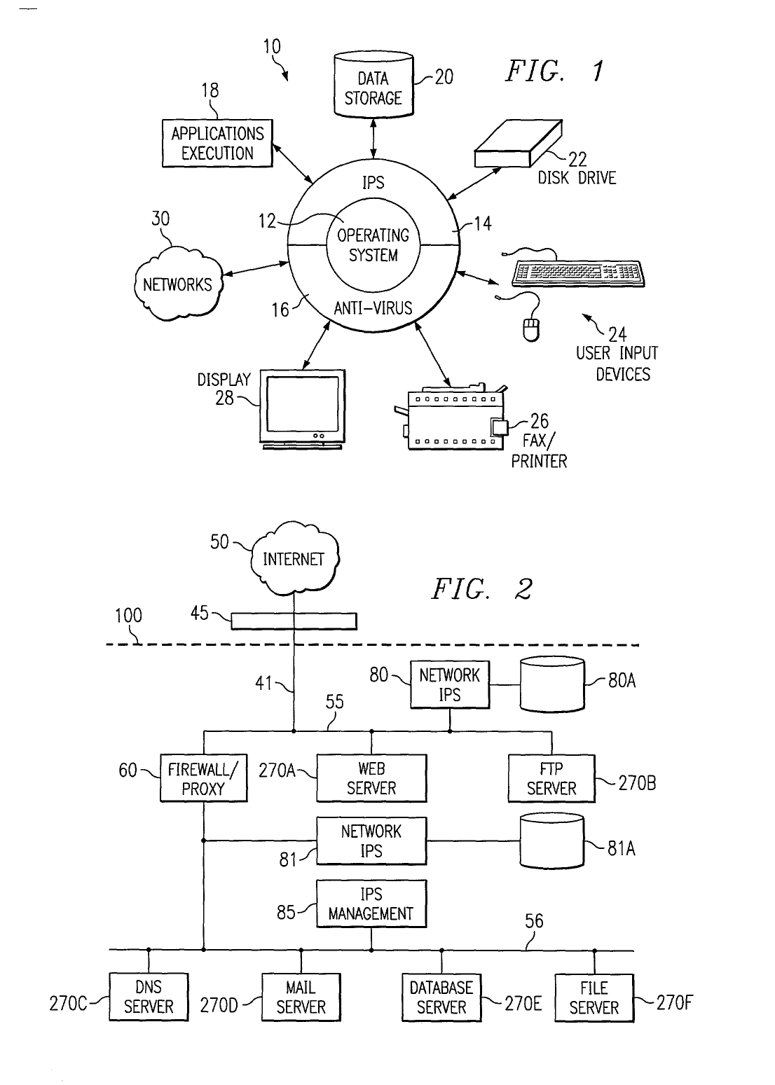

The preferred embodiment of the present invention and its advantages are best understood by referring to FIGS. 1 through 5 of the drawings, like numerals being used for like and corresponding parts of the various drawings.

A computer operating system is the software that runs and manages nearly every activity and device on a computer system. The operating system interfaces with hardware and software and generally sets the rules of engagement. In order to allow independent software manufacturers to design and implement intrusion protection system (IPS) and anti-virus systems that are compatible with the operating system, operating system makers generally publish or otherwise make available programming interfaces to the operating system. However, such architecture is far from ideal because the intrusion detection and anti-virus systems may not have access to interfaces and data beyond the boundaries of the operating system, which may provide heretofore unrealized advantages. The present invention proposes integrating the intrusion detection and anti-virus functionality into the operating system so that those operating system activities which may be subject to attack or infection can come under the scrutiny and monitor of the intrusion detection and anti-virus functions. Pursuant to the present invention, operating systems become mandatorily inoculated against intrusion attacks and virus infections. Furthermore, such defense system would not only protect computers that are the targets of such attacks, but the computers employed by hackers to develop the viruses, and the computers which unwittingly function as attack agents in a distributed attack would be subject to the same scrutiny and restrictions.

FIG. 1 is a simplified block diagram of the present invention 10, which includes an intrusion protection or detection system 14 and anti-virus system 16 integrated with a computer system's operating system 12 according to the teachings of the present invention. FIG. 1 attempts to illustrate the fact that a computer's operating system is involved in virtually every activity in the computer and serving as the interface between software applications 18 and peripheral devices such as data storage devices (file systems) 20, disk drives 22, user input devices (keyboard, mouse, touch pad, joysticks, etc.), facsimile machines and/or printers 26, display monitors 28, and computer networks 30 including the Internet. This architecture allows intrusion detection system 14 and anti-virus system 16 to be integrated with operating system 12 in a more comprehensive manner and at many levels than previously possible.

The operating system-integrated intrusion detection system may be one that employs network-based, host-based and inline intrusion protection as shown in FIG. 2. Each intrusion detection system component may be operating system-integrated or not. Network-based intrusion protection systems are generally deployed at or near the entry point of a network, such as a firewall. Network-based intrusion protection systems analyze data inbound from the Internet and collects network packets to compare against a database of various known attack signatures or bit patterns. An alert may be generated and transmitted to a management system that may perform a corrective action such as closing communications on a port of the firewall to prevent delivery of the identified packets into the network. Network-based intrusion protection systems generally provide real-time, or near real-time, detection of attacks. Thus, protective actions may be executed before damage is made to the targeted system. Furthermore, network-based intrusion protection systems are effective when implemented on slow communication links such as ISDN or T1 Internet connections. Moreover, network-based intrusion protection systems are easy to deploy. Typically, network-based intrusion protection systems are placed at or near the boundary of the network being protected.

Host-based intrusion protection systems, also referred to as “log watchers,” typically detect intrusions by monitoring system logs. Generally, host-based intrusion systems reside on the system to be protected. Host-based intrusion protection systems generally generate fewer “false-positives,” or an incorrect diagnosis of an attack, than network-based intrusion protection systems. Additionally, host-based intrusion protection systems may detect intrusions at the application level, such as analysis of database engine access attempts and changes to system configurations. Log-watching host-based intrusion protection systems generally cannot detect intrusions before the intrusion has taken place and thereby provide little assistance in preventing attacks. Log-watching host-based intrusion protection systems are not typically useful in preventing denial of service attacks because these attacks normally affect a system at the network interface card driver level. Furthermore, because log-watching hostbased intrusion protection systems are designed to protect a particular host, many types of network-based attacks may not be detected because of its inability to monitor network traffic. A host-based intrusion protection system may be improved by employing operating system application program interface hooks to prevent intrusion attempts.

Inline intrusion protection systems include embedded intrusion protection capabilities into the protocol stack of the system being protected. Accordingly, all traffic received by and originating from the system will be monitored by the inline intrusion protection system. Inline intrusion protection systems overcome many of the inherent deficiencies of network-based intrusion protection systems. For example, inline intrusion protection systems are effective for monitoring traffic on high-speed networks. Inline intrusion protection systems are often more reliable than networkbased intrusion protection systems because all traffic destined for a server having an inline intrusion protection system will pass through the intrusion protection layer of the protocol stack. Additionally, an attack may be prevented because an inline intrusion protection system may discard data identified as associated with an attack rather than pass the data to the application layer for processing. Moreover, an inline intrusion protection system may be effective in preventing attacks occurring on encrypted network links because inline intrusion protection systems may be embedded in the protocol stack at a layer where the data has been decrypted. Inline intrusion protection systems is also useful in detecting and eliminating a device from being used as an attack client in a distributed attack because outbound, as well as inbound, data is monitored thereby.

Referring to FIG. 2, one or more networks 100 may interface with the Internet 50 via a router 40 or another suitable device. In network 100, for example, two Ethernet networks 55 and 56 are coupled to the Internet 50 via router 40. Ethernet network 55 includes a firewall/proxy server 60 coupled to a web-content server 61 and a file transport protocol content server 62. Ethernet network 56 includes a domain name server (DNS) 70 coupled to a mail server 71, a database sever 72, and a file server 73. Network-based intrusion protection systems deployed on dedicated appliances 80 and 81 are disposed on two sides of firewall/proxy server 60 to facilitate monitoring of attempted attacks against one or more nodes of network 100 and to facilitate recording successful attacks that successfully penetrate firewall/proxy server 60. Network intrusion protection devices 80 and 81 may respectively include (or alternatively be connected to) databases 80a and 81a containing known attack signatures. Accordingly, network intrusion protection device 80 may monitor all packets inbound from Internet 50. Similarly, network intrusion protection device 81 monitors and compares all packets that passed by firewall/proxy server 60 for delivery to Ethernet network 56.

An IPS management node 85 may also be included in network 100 to facilitate configuration and management of the intrusion protection system components included in network 100. In view of the deficiencies of network-based intrusion protection systems, inline and/or host-based intrusion protection systems may be implemented within any of the various nodes of Ethernet networks 55 and 56, such as node 85. Additionally, management node 85 may receive alerts from respective nodes within network 100 upon detection of an intrusion event.

Preferably, network intrusion protection devices 80 and 81 are dedicated entities for monitoring network traffic on associated links of network 100. To facilitate intrusion protection in high speed networks, network intrusion protection devices 80 and 81 preferably include a large capture RAM (random access memory) for capturing packets as the arrive on respective Ethernet networks 55 and 56. Additionally, it is preferable that network intrusion protection devices 80 and 81 respectively include hardware-based filters for filtering high-speed network traffic. Filters may be alternatively implemented in software at a loss of speed and corresponding potential losses in protective abilities provided thereby to network 100. Moreover, network intrusion protection devices 80 and 81 may be configured, for example by demand of IPS management node 85, to monitor one or more specific devices rather than all devices on a network. For example, network intrusion protection device 80 may be instructed to monitor only network data traffic addressed to web server 61. Hybrid host-based and inline-based intrusion protection system technologies may be implemented on all other servers on Ethernet networks 55 and 56 that may be targeted in a distributed system attack. A distributed intrusion protection system such as the one described above may be integrated with any number of platforms, such as UNIX, WINDOWS NT, WINDOWS, LINUX, etc.

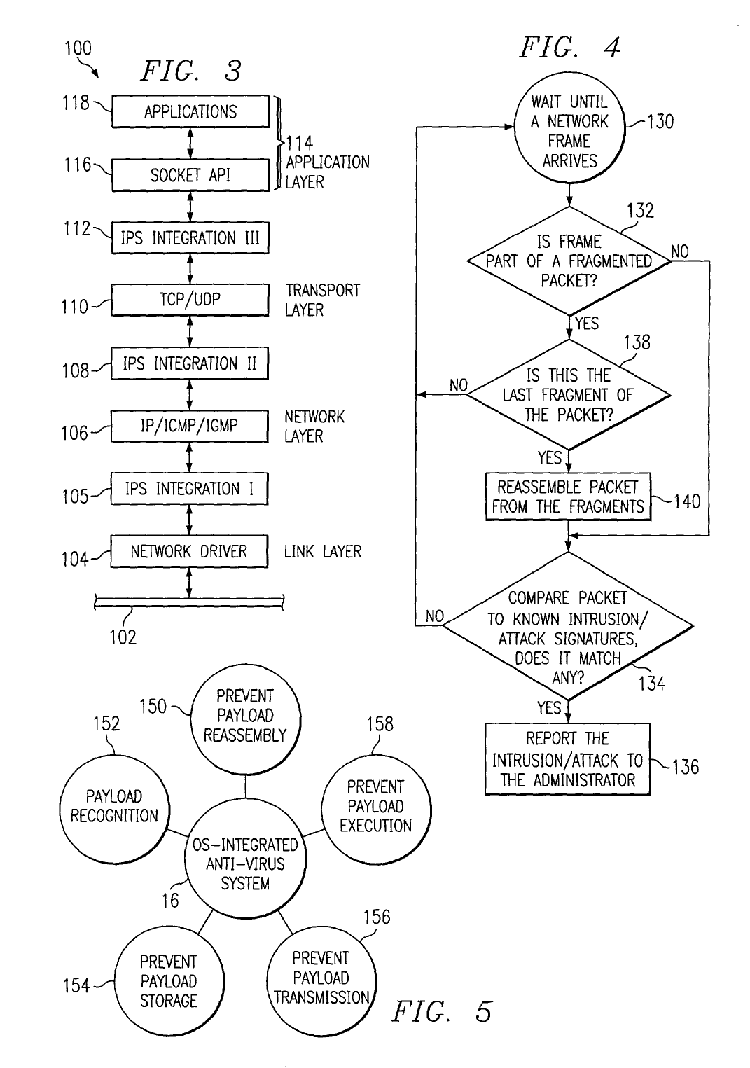

FIG. 3 is a block diagram of an embodiment of an intrusion protection system integrated between predetermined layers of a layered protocol 100 according to the teachings of the present invention. Network traffic on a network link 102 is captured or received by a network driver 104. Generally, network driver 104 performs functionality in the link layer of a networking protocol, such as the TCP/IP protocol suite. The link layer, sometimes also called the data link layer, typically includes the device driver in the operating system and the corresponding network interface card in the computer. The link layer handles the details of interfacing with network cable 102.

A first interface or access point of the OS-integrated intrusion detection and anti-virus systems of the present invention includes IPS integration I layer 105. IPS integration I 105 can filter on raw network frames to protect IP stack 106 disposed above it in the network layered architecture. IP gives the host machine basic firewall capabilities, in addition to preventing hostile frames which target vulnerabilities in IP layer 106.

IP/ICMP/ICMP protocols in network layer 106 is disposed above IP integration I 105 and handles the routing of data packets in the network. The Internet Protocol (IP) is a connectionless datagram delivery service. Internet Control Message Protocol (ICMP) is used to communicate error messages and other conditions that require attention. Internet Group Management Protocol (IGMP) is a protocol that can be used to perform message multicasting. Conventional intrusion detection systems and anti-virus systems are able to hook into the program interface between the link layer and the network layer.

A second interface or access point of the OS-integrated intrusion detection and anti-virus systems of the present invention includes IPS integration II 108 disposed between network layer 106 and transport layer 110. IPS integration II 108 indicates that the integrated intrusion detection and anti-virus systems are able to access the data, session and control information that pass between these two protocol layers. Transport layer 110 may use two different protocols, TCP (transmission control protocol) and UDP (user datagram protocol) to move data between two hosts for the application layer above it. TCP provides a reliable connection-oriented protocol, but UDP does not guarantee that the datagrams will reach the destination. Disposed above transport layer 110 and below application layer 114 is IPS integration III 112. Integration with the operating system at IPS integration III 112 allows access to the data, session and control information that pass between transport layer 110 and application layer 114. Application layer 114 may include a socket API (application program interface) 116 and application software itself 118. Application layer 114 handles the details of the particular application, such as telnet, FTP (file transport protocol), SMTP (simple mail transfer protocol), and SNMP (simple network management protocol).

Data is transmitted in the network as frames. Network driver 104 receives the data frames, strips the link layer header information and passes the frames up the protocol stack to network layer 106. Network layer 106 assembles the frames into IP datagrams, as necessary. IPS integration II 108 is able to intercept and access the assembled IP datagrams and derive session state information therefrom. The ability to monitor the assembled IP datagrams allows the intrusion detection system to recognize intrusions such as fragmented attacks, which is described in more detail below with reference to FIG. 4. Another point at which the OS-integrated system can access the data is between application layer 114 and transport layer 110. This provides access to the data streams for all applications to correlate socket data streams to the process that is transmitting or receiving them. Since data fragmentation is least likely or minimal at this level, this is the best point to monitor the data streams.

In comparison, intrusion detection and anti-virus systems not integrated with the operating system can only access the raw data frames passed between link layer 104 and network layer 106. These raw data frames represent fragmented data, which typically would not provide some of the information needed to achieve effective intrusion detection or virus detection. It should be noted that OS-integrated intrusion protection system of the present invention may comprise layers 105, 108 and 112 that operate along the layered protocol stack with optional “insertion” therein to accomplish certain tasks.

FIG. 4 is a top level flowchart showing the detection of fragmented network attack according to the present invention. In a fragmented network attack, fragmentation is used to hide the signature of the attack tool. For example, the IP header may be fragmented into two or more frames. Therefore, when an intrusion detection system compares the frames one at a time to its signature file, it is unable to recognize the signature in the fragmented headers. In block 130, the OS-integrated intrusion detection system waits until a frame arrives. By examining the IP header, such as the identification field containing the IP datagram identifier, the flag field set to indicate more fragments, and the fragment offset field indicating the number of bytes the particular fragments is offset from the beginning of the datagram, a determination is made as to whether the received frame is a fragmented packet, as shown in block 132. If it is not a fragment, then the packet in the frame is compared to known intrusion signatures and viruses, as shown in block 134. If there is a match, then remedial or responsive action is taken, such as reporting to the system administrator, as shown in block 136. If on the other hand the received frame is a fragmented datagram, then in block 138 a determination is made as to whether the frame is the last fragment of the datagram. If it is not the last fragment, then execution loops back to blocks 130 and 132 to collect all the remaining fragments. Once all the fragments are received, they are reassembled to form the original datagram, as shown in block 140, and then compared to known signatures of viruses and intrusions in block 134. Previously, an intrusion detection or anti-virus system is only able to intercept data between the data link layer and the network layer, where the fragments have not yet been assembled. IPS integration I layer 105 provides this level of functionality as previous IDS technologies. However, at IPS integration II level 108, the fragments have been reassembled and therefore accessible to the intrusion detection system to detect fragmented attacks.

FIG. 5 is a simplified diagram illustrating the comprehensive nature of an OS-integrated anti-virus system 16 in detecting and preventing a virus infection of the computer system. It is known that viruses are transmitted via I/O interface devices such as diskettes, CD ROMs, network drivers, etc. In order to succeed, virus payloads may also need to be reassembled via some protocol, decryption or specification. The virus may also need to be stored in some media to hibernate until execution or some triggering event. Finally, viruses need to be executed by the processor to inflict their damage. The programming interface hooks provided by the operating system maker does not sufficiently provide for policing and monitoring in each of these areas. OS-integrated anti-virus system 16 would provide for the prevention of virus payload assembly (150) if a virus is detected, since fragmented virus payloads can be accessed and recognized upon reassembly (152). Furthermore, OS-integrated anti-virus system 16 would prevent storage of the virus payload (154), and further transmission of the virus payload to other host processors (156). Finally, execution of the virus payload is also monitored and avoided by OS-integrated anti-virus system 16 (158). These functional blocks may represent either hardware modules or software processes that serve the functionality described.

Because the operating system controls and manages virtually all aspects of the computer system, anti-virus and intrusion protection systems integrated with the operating system would allow it to monitor all traffic, executions of code, and requests for resources in a much more comprehensive manner. Because all computer systems require an operating system, the computer systems would be inoculated in a mandatory manner against intrusions and viruses. An OS-integrated intrusion protection and anti-virus system would be less likely to be foiled or bypassed than add-on software applications. Such an integrated system is also advantageous to disarm the intrusion or virus attack attempts at the originating computer itself by detecting the signature and preventing its storage and transmission to other computers.

What is claimed is:

1. A computer comprising:
an operating system controlling a computer resource; and
an intrusion detection system integrated with the operating system and operable to monitor the computer resources to detect and prevent intrusion attempts.

2. The computer, as set forth in claim 1, wherein the computer resource is selected from the group consisting of data storage system, input/output system, a networking system, an application program execution environment, and interfaces to peripheral devices.

3. The computer, as set forth in claim 1, wherein the computer resource comprises an application program execution environment and a networking system under the control of the operating system and monitored by the intrusion detection system to detect, prevent and report intrusion attempts.

4. The computer, as set forth in claim 1, further comprising an anti-virus system integrated with the operating system and operable to monitor the data storage system, input/output system, networking system, application program execution environment, and interfaces to peripheral devices to detect the presence of at least one virus.

5. The computer, as set forth in claim 1, further comprising an anti-virus system integrated with the operating system and operable to monitor the data storage system, input/output system, networking system, application program execution environment, and interfaces to peripheral devices to detect and report the presence of at least one virus.

6. The computer, as set forth in claim 2, wherein intrusion detection is integrated with a networking stack of the networking system above the link layer operable to access raw network frames.

7. The computer, as set forth in claim 2, wherein the intrusion detection system is integrated with a networking stack of the networking system above the network layer operable to access reassembled fragments.

8. The computer, as set forth in claim 2, wherein the intrusion detection system is integrated with a networking protocol stack of the networking system above the transport layer.

9. The computer, as set forth in claim 2, wherein the intrusion detection system is integrated with a networking stack of the networking system between the network layer and the transport layer and between the transport layer and the application layer.

10. The computer, as set forth in claim 5, wherein the anti-virus system comprises a module operable to prevent reassembly of a virus.

11. The computer, as set forth in claim 5, wherein the anti-virus system comprises a module operable to recognize a virus.

12. The computer, as set forth in claim 5, wherein the anti-virus system comprises a module operable to prevent storage of a virus.

13. The computer, as set forth in claim 5, wherein the anti-virus system comprises a module operable to prevent transmission of a virus.

14. The computer, as set forth in claim 2, wherein the anti-virus system comprises a module operable to prevent execution of a virus.

15. A method comprising:
executing an OS-integrated intrusion detection system; and
monitoring at least one computer resource to detect and prevent intrusion attempts.

16. The method, as set forth in claim 15, wherein monitoring at least one computer resource comprises monitoring at least one computer resource selected from the group consisting of a data storage system, an input/output system, a networking system, an application program execution environment, and interfaces to peripheral devices.

17. The method, as set forth in claim 15, wherein monitoring at least one computer resource comprises reporting intrusion attempts.

18. The method, as set forth in claim 16, further comprising integrating the intrusion detection system with a networking system above the link layer operable to access raw network frames.

19. The method, as set forth in claim 15, further comprising integrating the intrusion detection system with a networking stack of the networking system above the network layer operable to access reassembled fragments.

20. The method, as set forth in claim 15, further comprising integrating the intrusion detection system with a networking protocol stack of the networking system above the transport layer.

21. The method, as set forth in claim 15, further comprising integrating the intrusion detection system with a networking stack of the networking system between the network layer and the t ransport layer, and between the transport layer and the application layer.

22. A method comprising:
executing an OS-integrated anti-virus system; and
monitoring at least one computer resource to detect the presence of at least one virus.

23. The method, as set forth in claim 22, wherein monitoring at least one computer resource comprises monitoring at least one computer resource selected from the group consisting of a data storage system, an input/output system, a networking system, an application program execution environment, and interfaces to peripheral devices.

24. The method, as set forth in claim 22, wherein monitoring at least one computer resource comprises reporting the presence of at least one virus.

25. The method, as set forth in claim 22, wherein the step of monitoring comprises detecting the reassembly of a virus.

26. The method, as set forth in claim 22, wherein the step of monitoring comprises recognizing a virus.

27. The method, as set forth in claim 22, wherein the step of monitoring comprises preventing the storage of a virus.

28. The method, as set forth in claim 22, wherein the step of monitoring comprises preventing the transmission of a virus.

29. The method, as set forth in claim 22, wherein the step of monitoring comprises preventing the execution of a virus.
